(19) United States
(12) Patent Application Publication
(10) Pub. No.: US 2003/0047391 A1
(43) Pub. Date: Mar. 13, 2003

(54) Wheel chock

(76) Inventor: Kurt A. Ericson, Forest Lake, MN (US)

Correspondence Address: Kurt C. Ericson, 568 First Avenue Southwest, Forest Lake, MN, 55025, US

(21) Appl. No.: 09/953,330

(22) Filed: Sep. 12, 2001

(51) Int. Cl. B60T 3/00

(52) U.S. Cl. 188/32; 188/2 R

(57) ABSTRACT

A wheel chock includes a first chock member having a receiving slot therein, a second chock member, and an elastic member. The elastic member is fixed at one end to said first chock member, and its opposite end joins the second chock member to the first chock member. The elastic member is adapted to securely engage said receiving slot of said first chock member when the wheel chock is in use about a tire.

### FIELD OF THE INVENTION

The present invention relates generally to wheel chocks. The invention relates specifically to an improved wheel chock for aircraft that provides prevention of unintentional rotation of an aircraft tire when the aircraft is parked.

### BACKGROUND OF THE INVENTION

In aircraft-related businesses, and particularly in businesses of fixed base operators (commonly known as “FBOs”) there has continually been a need for devices and methods which aid in securing aircraft. Such devices and methods range from simply setting a parking brake of a large aircraft, to “tying-down” an aircraft via ropes or chains, and to positioning an aircraft in an enclosed hangar. Hangaring an aircraft may be costly in terms of using valuable enclosed space, while tying down an aircraft is typically time-consuming and may be difficult in adverse weather conditions. Simply setting a parking brake may be wholly inadequate, particularly for a light aircraft in strong and gusty wind conditions.

Thus, as an alternative to the aforementioned devices and methods, many FBOs and aircraft owners elect to use devices known as “wheel chocks”. A wheel chock aids in preventing rotation or movement of an aircraft tire. Commonly, wheel chocks are simply fabricated from two blocks of wood. The two wood blocks can be cut or milled into corresponding wedge shapes to snugly fit about front and rear portions of the aircraft tire, respectively, in the well-known manner of such chocks. Usually, the two wedge shaped blocks are joined by a rope, to aid in keeping them together as a single chock unit. However, wood is prone to deterioration through environmental effects, and due to exposure to aviation fuel and lubricants that may be present on an FBO ramp. Also, it has been observed that on wet ramp surfaces, or as a parked aircraft rocks or moves in strong wind conditions, wood chocks may easily slip and become ineffective in holding in place or securing the aircraft tire.

Furthermore, in busy flight training environments such as is found at many FBOs, simple wood chocks are subject to great wear and tear from repetitive use and misuse.

In response to these problems, several wheel chocks and like devices have been proposed. Among these, for example, is a “WHEEL CHOCK FOR AIRCRAFT” as disclosed in U.S. Pat. No. 5,427,210 issued to Willaford. Therein, an elaborate wheel chock includes U-shaped channel members, a cylindrical rod, a chain, and a pad lock.

Known or patented wheel chocks suffer from several drawbacks, however. Specifically, the chocks may be expensive and complex to build, difficult to use in a busy FBO ramp environment, and cumbersome and heavy.

Therefore, there exists a need for a wheel chock that does not suffer from the many disadvantages of wood chocks, that remains securely in place about an aircraft tire regardless of weather or ramp conditions, is lightweight, is not susceptible to adverse effects of frequent use, and is simple and inexpensive to manufacture.

### SUMMARY OF THE INVENTION

An object of the present invention is to provide a wheel chock that is substantially impervious to environmental effects.

Another object of the present invention is to provide a wheel chock that remains securely in place about an aircraft tire regardless of weather or ramp conditions.

Yet another object of the present invention is to provide a wheel chock that is not susceptible to adverse effects of frequent use.

A further object of the present invention is to provide a wheel chock that is lightweight, and is simple and inexpensive to manufacture.

In accordance with the present invention, a wheel chock includes a first chock member having a fixed end portion and an opposing slot end portion, a second chock member having opposing first and second end portions, and an elastic member having a fixed end and an engaging end. The fixed end of the elastic member is secured to the fixed end portion of the first chock member. The elastic member passes through the first end portion of the second chock member and, sequentially, through the opposing second end portion of the second chock member. The elastic member thus acts to join together the first and second chock members as a unitary wheel chock. In use about an aircraft tire, the engaging end of the elastic member engages the slot end portion of the first chock member. The elastic member then acts to tightly draw the first and second chock members against the tire.

### BRIEF DESCRIPTION OF THE DRAWINGS

FIG. 1 is an illustration of an exemplary wheel chock constructed in accordance with the present invention and shown in use, as having been secured about an aircraft tire.

FIG. 2 is a top view of the wheel chock of FIG. 1.

### DETAILED DESCRIPTION OF THE INVENTION

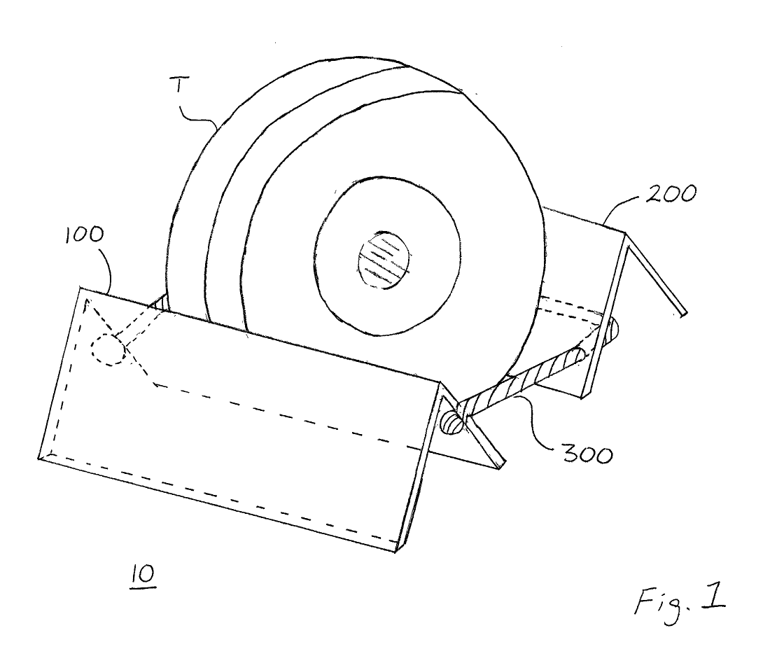

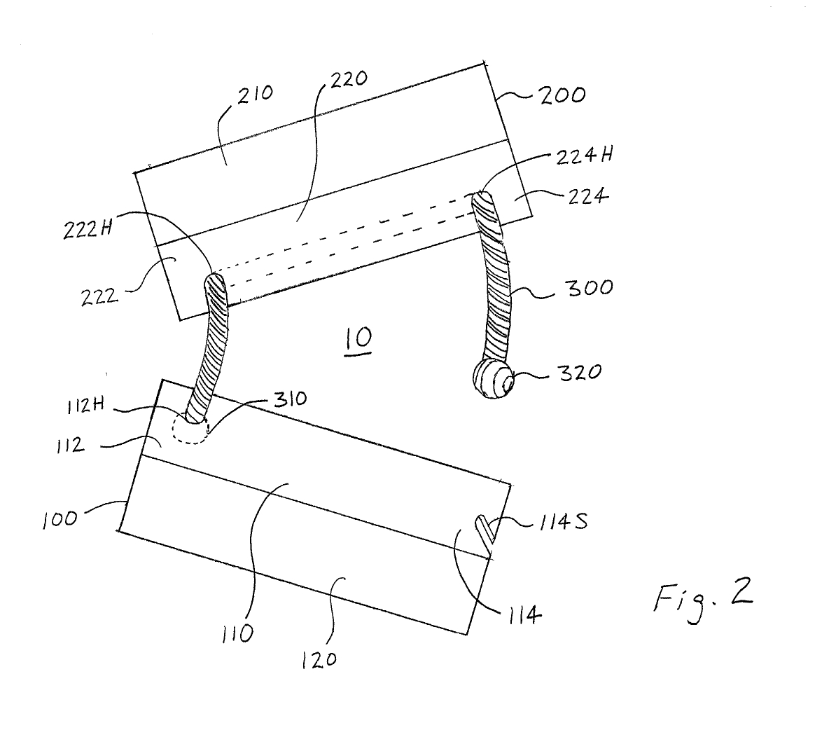

Referring to FIGS. 1 and 2, there shown are in use and top views, respectively, of a wheel chock 10 of the present invention. Specifically, in FIG. 1, wheel chock 10 is depicted as having been secured about a tire T. Tire T may be, for example, part of an aircraft nose gear assembly (not illustrated). In FIG. 2, wheel chock 10 is shown as being not in use, via a top view, so that components thereof may be readily ascertained.

In the figures, wheel chock 10 includes an angle bracket shaped first chock member 100, an angle bracket shaped second chock member 200, and an elastic member 300. Elastic member 300, as will be further described, joins members 100 and 200 to provide, in combination, wheel chock 10.

As particularly shown in FIG. 2, first chock member 100 includes a first face 110 and a second face 120. First face 1 10 has a fixed end portion 112, and an opposing slot end portion 114. A first hole 112H is provided through fixed end portion 112, while a receiving slot 114S is provided in slot end portion 114.

Similar to first chock member 100, second chock member 200 includes a first face 210 and a second face 220. Second face 220 has a first end portion 222, and an opposing second end portion 224. A first hole 222H is provided through first end portion 222, while a second hole is 224H is provided through second end portion 224.

Finally, a fixed end 310 of elastic member 300 is fixed to fixed end portion 112 of first chock member 100. Although not specifically illustrated, fixed end 310 may be provided by any number of suitable techniques, including by simply tying a sufficiently large knot in fixed end 310 so that elastic member is securely held in place at first hole 112H. As may be discerned from the figures, elastic member 300 is then passed sequentially through hole 112H, hole 222H, and finally through hole 224H. Elastic member 300 is then provided with a terminating ball 320 that is secured to an end of member 300 opposite fixed end 310 thereof. Of course, a sufficiently large knot may be tied in member 300 as an alternative to terminating ball 320.

In an exemplary construction of wheel chock 10, first and second chock members 100 and 200, respectively, are constructed from angle bracket shaped solid aluminum having a length of about 12″ and a thickness of about ¼″. Holes 112H, 222H, and 224H are drilled through the aluminum, and are located about ½″ from both bottom edges and from ends of faces 110 and 220, respectively. Slot 114S is cut from the aluminum, and is located about 2″ from the bottom edge of face 110. Elastic member 300 may preferably be any commercially available bungee cord having a diameter of ⅜″.

In use of wheel chock 10, members 100 and 200 are positioned on opposite sides of an aircraft tire T (as shown in FIG. 1). Elastic member 300 is then stretched by a user of chock 10 such that terminating ball 320 may be placed into and engaged by slot 114S (as shown in FIG. 2). It is to be particularly appreciated that as, for example, the aircraft rocks in strong wind conditions thereby moving tire T, elastic member 300 acts to draw chock members 100 and 200 closer together and hence more tightly against tire T. It is also to be appreciated that the preferred complimentary angle bracket shaped members 100 and 200 inhibit movement of chock 10 on ramp surfaces.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto.

For example, any suitable corrosion-proof metal could be substituted for aluminum in construction of chock members 100 and 200. Although not preferred, members 100 and 200 could also be simply fabricated from wood. Additionally, any suitable cotton or nylon cord or rope could be substituted for elastic member 300, depending upon a degree of elasticity desired. Further, elastic member 300 could also be a simple coil spring.

Of course, the compositions, sizes, strengths, and dimensions of the aforedescribed components of chock 10 are all a matter of design choice, and may be modified to suit particular needs; e.g., correspondingly larger sizes and dimensions of the components for larger aircraft.

Lastly, it is to be understood that any suitable alternatives may be employed to provide the wheel chock of the present invention.

Accordingly, these and other various changes or modifications in form and detail of the present invention may also be made therein, again without departing from the true spirit and scope of the invention as defined by the appended claims.

What is claimed is:

1. A wheel chock, comprising:
a first chock member having a receiving slot therein;
a second chock member; and
an elastic member, said elastic member being fixed at one end thereof to said first chock member, with an opposite end of said elastic member joining said second chock member to said first chock member,
wherein said elastic member is adapted to securely engage said receiving slot of said first chock member when the wheel chock is in use about a tire.

2. A wheel chock, comprising:
a first chock member being substantially angle bracket shaped and having (i) a first face and a second face, wherein said first face has a fixed end portion and an opposing slot end portion, (ii) a first hole provided through said fixed end portion of said first face, and (iii) a receiving slot provided in said slot end portion of said first face;
a second chock member being substantially angle bracket shaped and similar to said first chock member, and having (i) a first face and a second face, wherein said second face has a first end portion and an opposing second end portion, (ii) a first hole provided through said first end portion of said second face, and (iii) a second hole provided in said second end portion of said second face; and
an elastic member fixed to said fixed end portion of said first face of said first chock member near said first hole thereof, said elastic member passing sequentially through (i) said first hole of said first chock member, (ii) said first hole of said second chock member, and (iii) said second hole of said second chock member,
wherein said elastic member is adapted to securely engage said receiving slot of said first chock member when the wheel chock is in use about a tire.

3. The wheel chock of claim 1, wherein said first and second chock members are constructed from aluminum.

4. The wheel chock of claim 1, wherein said elastic member is selected from a group consisting of a bungee cord, a cotton cord, a nylon cord, a rope, and a coil spring.
